(19) United States
(12) Patent Application Publication
(10) Pub. No.: US 2026/0276996 A1
(43) Pub. Date: Sep. 17, 2026

(54) DISPLAY STRUCTURE

(71) Applicant: Dispelix OY, Espoo (FI)

(72) Inventor: Aapo MALKAMÄKI, Espoo (FI)

(21) Appl. No.: 19/480,238

(22) PCT Filed: May 2, 2024
(86) PCT No.: PCT/FI2024/050208

§ 371 Date: Oct. 30, 2025

(30) Foreign Application Priority Data
May 4, 2023 (FI) 20235496

(51) Int. Cl. G02B 27/01; G02B 27/00; G02B 27/42

(52) U.S. Cl. CPC G02B 27/0172; G02B 27/0081; G02B 27/4205; G02B 27/4272; G02B 2027/0123

(57) ABSTRACT

According to an example embodiment, display structure comprises a waveguide, an in-coupling structure, a first one-dimensional diffractive grating structure, and a second one-dimensional diffractive grating structure. The first one-dimensional diffractive grating structure is configured to receive the first set of in-coupled beams, and to diffract the first set of in-coupled beams producing a first diffracted set of beams. The second one-dimensional diffractive grating structure configured to receive the second set of in-coupled beams, and to diffract the second set of in-coupled beams producing a second diffracted set of beams. The first one-dimensional diffractive grating structure is further configured to receive, from the second diffracting structure, the second diffracted set of beams, and to out-couple the second diffracted set of beams from the waveguide.

### TECHNICAL FIELD

The present disclosure relates to the field of diffractive optics, and more particularly to a display structure and a display device.

### BACKGROUND

In display structures used for augmented reality (AR) applications, such as AR glasses, a waveguide with appropriately designed in-coupling and out-coupling structures can be used to create multiple replicas of an exit pupil of a microprojector in front of a user's eye, forming an eyebox.

The field of view (FOV) of such display structure may be limited by the size of the waveguide. It is difficult to increase the FOV without significantly increasing the size of the waveguide. Another solution is to stack waveguides. Stacked waveguides are however thicker and may be heavier.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object to provide a display structure and a display device. Some embodiments increase the field of view (FOV) of the display structure (e.g., without significantly increasing the surface area of the grating area), and/or reduce the surface area of the grating area.

The foregoing and other objects are achieved by the features of the independent claims. Further implementation forms are apparent from the dependent claims, the description and the figures.

According to a first aspect, a display structure comprises a waveguide, an in-coupling structure, a first one-dimensional diffractive grating structure, and a second one-dimensional diffractive grating structure. The in-coupling structure is configured to couple a first set of input beams into the waveguide as a first set of in-coupled beams, and a second set of input beams into the waveguide as a second set of in-coupled beams. The first one-dimensional diffractive grating structure is configured to receive the first set of in-coupled beams, and to diffract the first set of in-coupled beams producing a first diffracted set of beams. The second one-dimensional diffractive grating structure configured to receive the second set of in-coupled beams, and to diffract the second set of in-coupled beams producing a second diffracted set of beams. The first one-dimensional diffractive grating structure is further configured to receive, from the second diffracting structure, the second diffracted set of beams, and to out-couple the second diffracted set of beams from the waveguide.

According to an example embodiment of the first aspect, the second one-dimensional diffractive grating structure is further configured to receive, from the first one-dimensional diffractive grating structure, the first diffracted set of beams, and to out-couple the first diffracted set of beams from the waveguide.

According to an example embodiment of the first aspect, the in-coupling structure comprises an in-coupling one-dimensional diffractive grating with an in-coupling grating vector, the first one-dimensional diffractive grating structure corresponds to a first grating vector, the second one-dimensional diffractive grating structure corresponds to a second grating vector, and wherein a sum of the in-coupling grating vector, the first grating vector, and the second grating vector is substantially equal to zero.

According to an example embodiment of the first aspect, the display structure further comprises an interspaced diffracting structure extending at least partially between the first one-dimensional diffractive grating structure and the second one-dimensional diffractive grating structure.

According to an example embodiment of the first aspect, the interspaced diffracting structure comprises an overlap of the first one-dimensional diffractive grating structure and of the second one-dimensional diffractive grating structure.

According to an example embodiment of the first aspect, the interspaced diffracting structure comprises a two-dimensional diffractive grating combining a first grating vector of the first one-dimensional diffractive grating structure and a second grating vector of the second one-dimensional diffractive grating structure.

According to an example embodiment of the first aspect, the display structure further comprises: a second in-coupling structure configured to couple a third set of input beams into the waveguide as a third set of in-coupled beams; and a third one-dimensional diffractive grating structure configured to receive the third set of in-coupled beams, and to diffract the third set of in-coupled beams producing a third diffracted set of beams; wherein the second one-dimensional diffractive grating is further configured to receive, from the third one-dimensional diffractive grating structure, the third diffracted set of beams, and to out-couple the third diffracted set of beams from the waveguide.

According to an example embodiment of the first aspect, the second in-coupling structure is further configured to couple a fourth set of input beams into the waveguide as a fourth set of in-coupled beams. The second one-dimensional diffractive grating is further configured to receive the fourth set of in-coupled beams, and to diffract the fourth set of in-coupled beams producing a fourth diffracted set of beams. The third one-dimensional diffractive grating structure is further configured to receive, from the second one-dimensional diffractive grating, the fourth diffracted set of beams, and to out-couple the fourth diffracted set of beams from the waveguide.

According to an example embodiment of the first aspect, the third one-dimensional diffractive grating structure is further configured to couple a sixth set of input beams into the waveguide as a sixth set of in-coupled beams; wherein the second one-dimensional diffractive grating structure is further configured to receive the sixth set of in-coupled beams, and to diffract the sixth set of in-coupled beams producing a sixth diffracted set of beams; wherein the second in-coupling structure is further configured to receive, from the second one-dimensional diffractive grating structure, the sixth diffracted set of beams, and to out-couple the sixth diffracted set of beams from the waveguide.

According to an example embodiment of the first aspect, the first one-dimensional diffractive grating structure is further configured to couple a fifth set of input beams into the waveguide as a fifth set of in-coupled beams; wherein the second one-dimensional diffractive grating structure is further configured to receive the fifth set of in-coupled beams and diffract the fifth set of in-coupled beams producing a fifth diffracted set of beams; the first in-coupling structure is further configured to receive, from the second one-dimensional diffractive grating structure, the fifth diffracted set of beams, and to out-couple the fifth diffracted set of beams from the waveguide.

According to a second aspect, a display device comprising a display structure according to any example embodiment of the first aspect.

According to an example embodiment of the second aspect, the display device comprises a scanner-based optical engine, e. g., a laser-scanning optical engine, for directing the one or more sets of input beams to the in-coupling structure.

According to an example embodiment of the second aspect, the display device is implemented as a see-through display device.

According to an example embodiment of the second aspect, the display device is implemented as a head-mounted display device.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1A illustrates a first and a second light paths on a display structure according to example embodiments;

FIG. 1B illustrates a first and a second light paths on a display structure according to another example embodiments;

FIGS. 2A and 2B illustrate cross-sectional representations of a display structure according to example embodiments;

FIG. 3A illustrates a k-space representation of the first and second light paths on a display structure according to FIG. 1A;

FIG. 3B illustrate a k-space representation of the first and second light paths on a display structure according to FIG. 1B;

FIGS. 4A, 4B, and 4 AB illustrate a plan view of a display structure according to an example embodiment; more specifically, FIG. 4A illustrates the functional areas for the first light path, FIG. 4B illustrates the functional areas for the second light path, FIG. AB illustrates the superposition of the functional areas for the first and second light paths;

FIG. 5 illustrates a schematic representation of a display structure according to an example embodiment;

FIGS. 6A and 6B illustrate cross-sectional representations of a display structure according to example embodiments;

FIG. 7 illustrates the first and second light paths as well as a third and fourth light paths of a display structure according to an example embodiment;

FIG. 8 illustrates a k-space representation of the first, second, third, and fourth light paths on a display structure according to the example embodiment of FIG. 7;

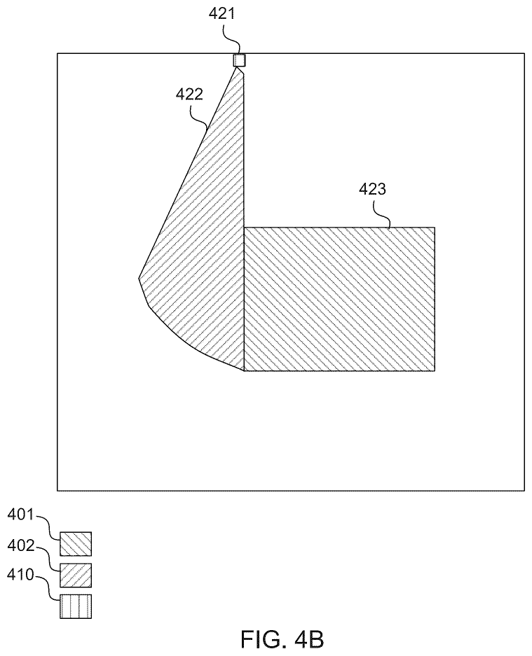

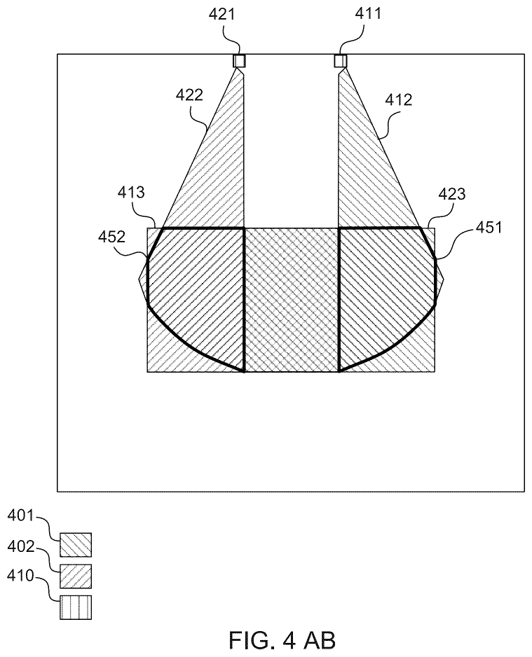

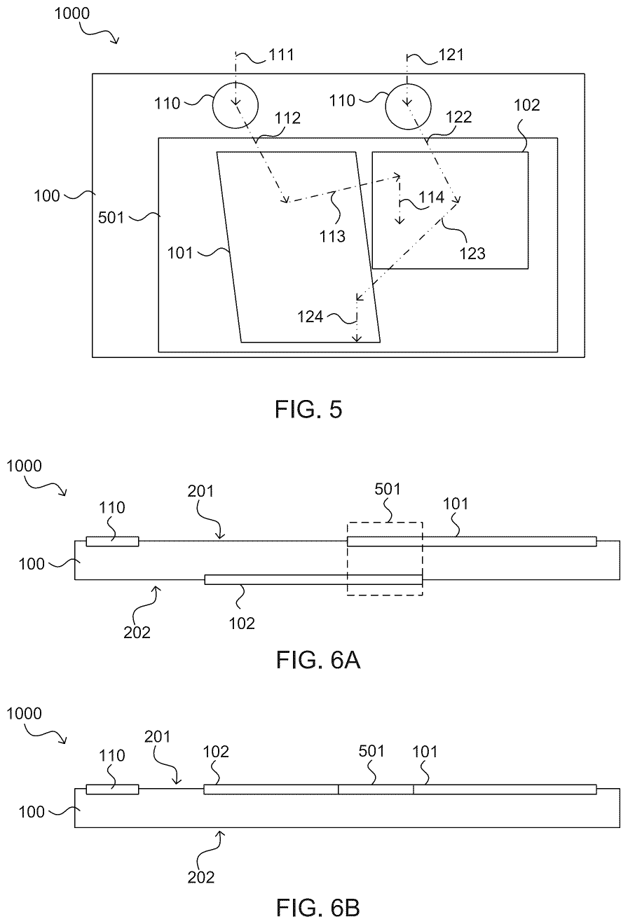

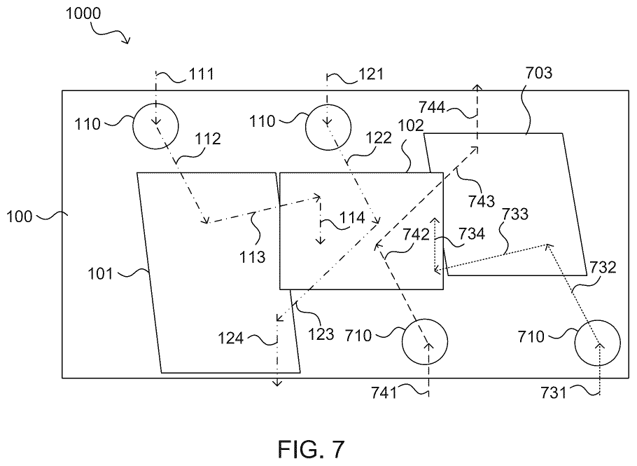

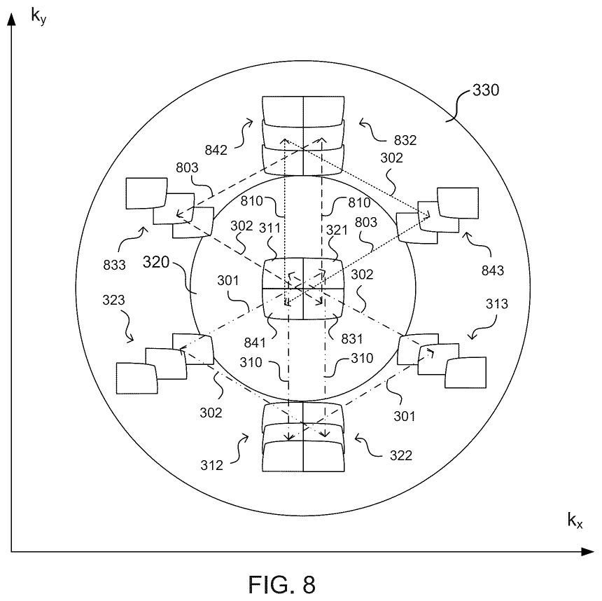

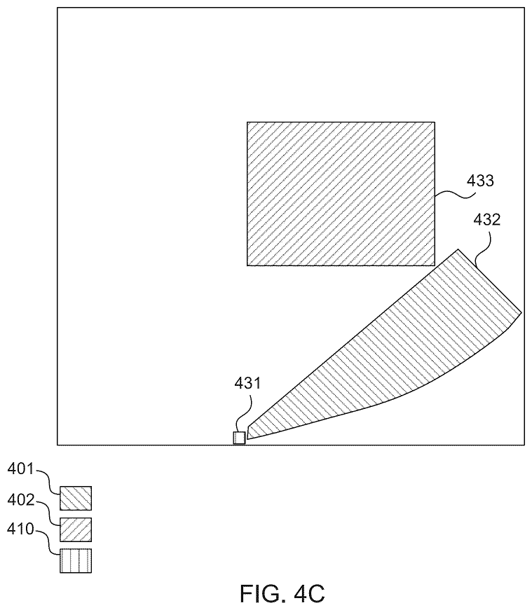

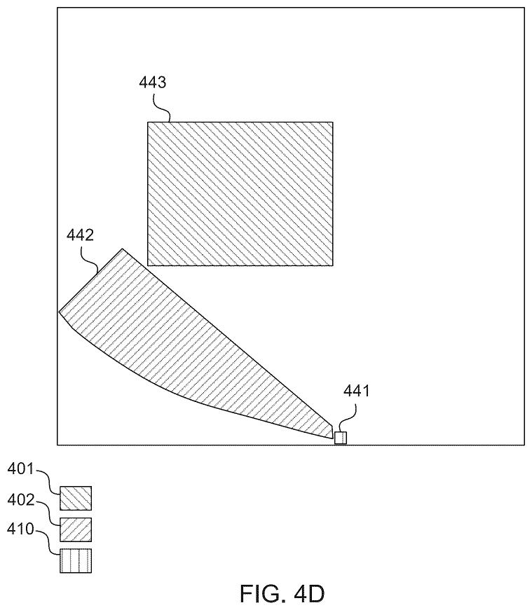

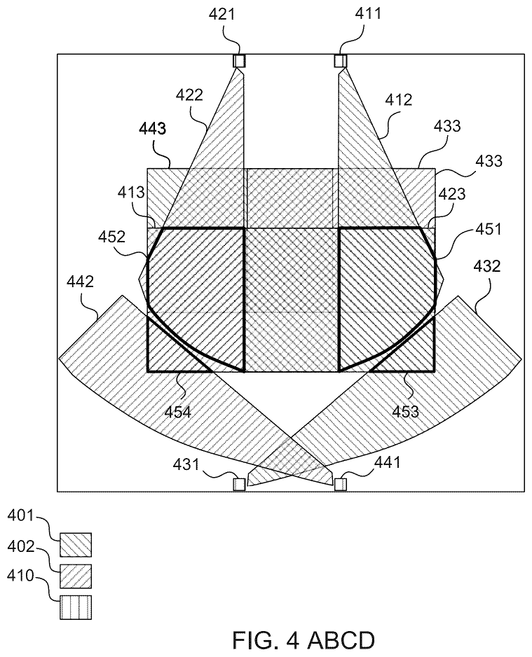

FIGS. 4C, 4D, and 4 ABCD illustrate a plan view of a display structure according to an example embodiment; more specifically, FIG. 4C illustrates the functional areas for the third light path, FIG. 4D illustrates the functional areas for the fourth light path, FIG. 4 ABCD illustrates the superposition of the functional areas for the first, second, third and fourth light paths;

FIG. 9 illustrates a schematic representation of a display structure according to an example embodiment;

FIG. 10 illustrates a k-space representation of beams diffracted by a display structure according to an example embodiment;

In the following, identical reference signs refer to similar or at least functionally equivalent features.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

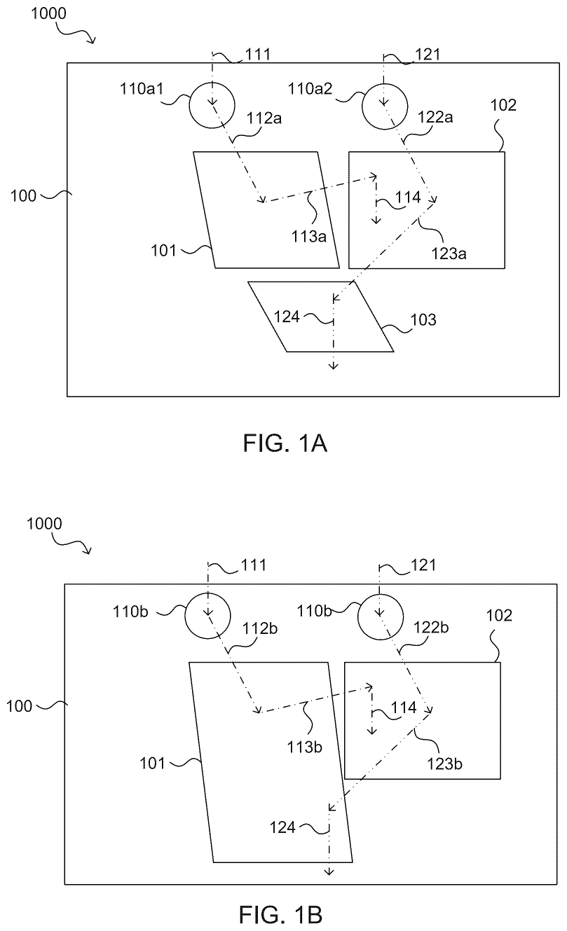

FIG. 1A illustrates a schematic representation of a display structure according to an example embodiment.

According to an example embodiment, a display structure 1000 comprises a waveguide 100.

The waveguide 100 may comprise, for example, a substantially planar waveguide. Alternatively, or additionally, the waveguide 100 may also comprise curved sections. For example, the waveguide 100 may correspond to a lens of augmented reality (AR) glasses.

The display structure 1000 may further comprise an in-coupling (IC) structure 110 (e.g., 110a1, and 1102 on FIG. 1A, and 110b on FIG. 1B) configured to couple light into the waveguide 100. The in-coupling diffractive structure 110 comprises at least one one-dimensional grating and/or at least one two-dimensional grating.

As illustrated by FIG. 1A, the in-coupling structure 110 may comprise a diffractive grating 110a1 configured to couple a first set of input beams 111 into the waveguide 100 as a first set of in-coupled beams 112a, and a diffractive grating 110a2 configured to couple a second set of input beams 121 into the waveguide 100 as a second set of in-coupled beams 122a.

As illustrated by FIG. 1B, in some embodiments, the in-coupling structure 110 may comprise a diffractive grating 110b configured to couple the first set of input beams 111 into the waveguide 100 as a first set of in-coupled beams 112b, and the second set of input beams 121 into the waveguide 100 as a second set of in-coupled beams 122b.

The first set of input beams 111 and the second set of input beams 121 may correspond to different angles within a field of view (FOV). For example, the first set of input beams 111 may correspond to a first section of the field of view, and the second set of input beams 121 may correspond to a second section of the field of view. Herein, a beam may also be referred to as a ray, a light beam, a light ray, or similar.

The sets of input beams 111, 121 may be generated by, for example, a scanner-based optical engine. The sets of input beams 111, 121 may represent an image generated by, for example, such an optical engine. Thus, the sets of input beams 111, 121 may also be referred to as, for example, image-bearing light rays/beams, im-age-carrying light rays/beams, and/or similar.

The in-coupling structure 110 may comprise, for example, at least one diffractive grating on a surface of the waveguide 100. The in-coupling structure 110 may couple the sets of input beams 111, 121 into the wave-guide 100 via diffraction. The in-coupling structure 110 may comprise two or more joint or disjoint grating areas.

The display structure 1000 may further comprise a first diffracting structure 101, and a second diffracting structure 102. The first diffracting structure 101 may comprise, for example, a one-dimensional diffractive grating on a surface of the waveguide 100. The second diffracting structure 102 may comprise, for example, a one-dimensional diffractive grating on a surface of the waveguide 100. The first diffracting structure 101 and the second diffracting structure 102 may be located on a same side of the waveguide 100 or on different sides of the waveguide 100.

As illustrated by FIGS. 1A and 1B, the first diffracting structure 101 acts as an exit pupil expansion (EPE) structure for the first set of in-coupled beams 112 (112a on FIGS. 1A, 112b on FIG. 1B). In particular, the first diffracting structure 101 is configured to receive the first set of in-coupled beams 112 and to diffract the first set of in-coupled beams 112 in a plurality of directions, producing a first diffracted set of beams 113 (113a on FIGS. 1A, 113b on FIG. 1B).

The second diffracting structure 102 acts as an out-coupling (OC) structure for the first diffracted set of beams 113. In particular, the second diffracting structure 102 may be configured to receive, from the first diffracting structure 101, the first diffracted set of beams 113, to out-couple the first diffracted set of beams 113 from the waveguide 100 as a first set of output beams 114. The second diffracting structure 102 may out-couple the first diffracted set of beams 113 from the waveguide 100 via diffraction.

The first set of output beams 114 may represent, for example, an expanded version of the image formed by the first set of input beams 111.

Beams 111, 112 (112a or 112b), 113 (113a or 113b), 114 form a first light path e. g., from the optical engine to the user eye.

The first set of in-coupled beams 112 and the first diffracted set of beams 113 can be guided inside the waveguide 100 via total internal reflection (TIR).

The first set of in-coupled beams 112 and the first diffracted set of beams 113 (may interact with the first diffracting structure 101 and/or the second diffracting structure 102 a plurality of times before the first diffracted set of beams 113 is out-coupled from the waveguide 100 as the first set of output beams 114.

The second diffracting structure 102 acts as an exit pupil expansion (EPE) structure for the second set of in-coupled beams 122 (122a on FIG. 1A, 122b on FIG. 1B). In particular, the second diffracting structure 102 is configured to receive the second set of in-coupled beams 122 and to diffract the second set of in-coupled beams 122 in a plurality of directions, producing a second diffracted set of beams 123 (123a on FIGS. 1A, 123b on FIG. 1B).

As illustrated by FIG. 1A, a second out-coupling (OC) structure 103 may be configured to receive, from the second diffracting structure 102, the second diffracted set of beams 123a, to out-couple the second diffracted set of beams 123a from the waveguide 100 as a second set of output beams 124. The second OC structure 103 may comprise, for example, a one-dimensional diffractive grating on a surface of the waveguide 100. The second OC structure 103 may out-couple the second diffracted set of beams 123a from the waveguide 100 via diffraction.

As illustrated by FIG. 1B, the first diffracting structure 101 may act as an out-coupling (OC) structure for the second diffracted set of beams 123b. In particular, the first diffracting structure 101 may be configured to receive, from the second diffracting structure 102, the second diffracted set of beams 123b, to out-couple the second diffracted set of beams 123b from the waveguide 100 as a second set of output beams 124. The first diffracting structure 101 may out-couple the second diffracted set of beams 123b from the wave-guide 100 via diffraction.

The second set of output beams 124 may represent, for example, an expanded version of the image formed by the second set of input beams 121.

Beams 121, 122 (122a or 122b), 123 (123a or 123b), 124 form a second light path e.g., from the optical engine to the user eye.

The second set of in-coupled beams 122 and the second diffracted set of beams 123 can be guided inside the waveguide 100 via total internal reflection (TIR).

The second set of in-coupled beams 122 and the second diffracted set of beams 123 may interact with the first diffracting structure 101 and/or the second diffracting structure 102 a plurality of times before the second diffracted set of beams 123 is out-coupled from the waveguide 100 as the second set of output beams 124.

It should be appreciated that the sets of beams illustrated in the embodiment of FIGS. 1A and 1B are only illustrative. In practical embodiments, the first diffracting structure 101 and/or the second diffracting structure 102 can diffract the sets of beams in a plurality of directions in a much more complex manner and the sets of beams can interact with the first diffracting structure 101 and/or the second diffracting structure 102 a plurality of times.

The first diffracting structure 101 and/or the second diffracting structure 102 simultaneously play the role of out-coupling (OC) structure and exit pupil expansion (EPE) structure. More specifically, the first diffracting structure 101 may act both as an exit pupil expansion (EPE) structure for the first set of in-coupled beams 112 and as an out-coupling (OC) structure for the second diffracted set of beams 123. Similarly, the second diffracting structure 102 may act both as an out-coupling (OC) structure for the first diffracted set of beams 113, and as an exit pupil expansion (EPE) structure for the second diffracted set of beams 122. The first set of input beams 111 and the second set of input beams 121 may correspond to different angles within a field of view. As such, the field of view (FOV) of the display structure 1000 can be increased without increasing the surface area of the structure. This may avoid and/or reduce the need for stacking waveguides and/or reduce the thickness of stacked waveguides.

According to an example embodiment, the first diffracting structure 101 comprises a one-dimensional diffractive grating and the second diffracting structure 102 comprises a one-dimensional diffractive grating. Herein, a diffractive grating may also be referred to as a surface-relief grating, a grating, a diffraction grating, or similar.

It should be understood that the geometry of the display structure 100 illustrated in the embodiment of FIG. 1 is only exemplary and the display structure may be implemented in various other ways.

According to an example embodiment, a display device comprises the display structure 100.

The display device may comprise a scanner-based optical engine, e.g., a laser-scanning optical engine, for directing the set of input beams to the in-coupling structure 102. Other types of optical engines may also be used.

The display device may be implemented as, for example, a see-through display device.

The display device may be implemented as, for example, a head-mounted display device.

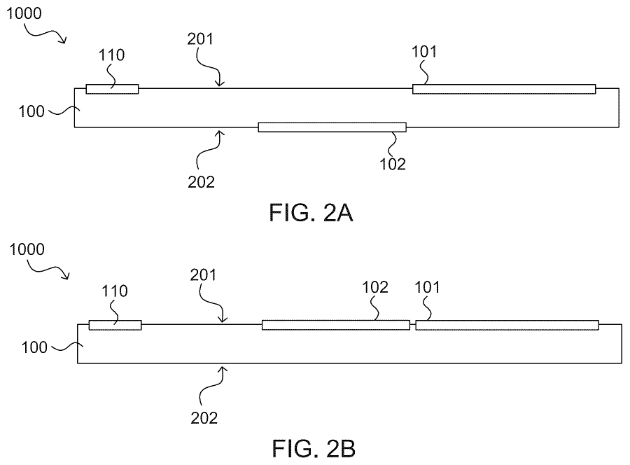

FIGS. 2A and 2B illustrate cross-sectional representations of a display structure according to example embodiments.

In the embodiment of FIG. 2A, the first diffracting structure 101 is located on the first side 201 of the waveguide 100, and the second diffracting structure 102 is located on a second side 202 of the waveguide 100.

FIG. 2B illustrates a cross-sectional representation of a display structure according to an example embodiment.

In the embodiment of FIG. 2B, the first diffracting structure 101 and the second diffracting structure 102 are located on a same side (e.g., first side 201) of the waveguide 100.

In any embodiment disclosed herein, the first diffracting structure 101 and/or the second diffracting structure 102 may be configured to out-couple the diffracted set of beams 113, 123 from the waveguide 100 as the set of output beams 114, 124 to the first side 201 or to the second side 202 of the waveguide 100. Thus, the side to which the first diffracting structure 101 and/or the second diffracting structure 102 is configured to out-couple the diffracted set of beams 113, 123 from the waveguide 100 does not depend on which side of the waveguide 100 the first diffracting structure 101 and/or the second diffracting structure 102 is positioned.

In any embodiment disclosed herein, the in-couple structure 110 may be configured to in-couple the sets of input beams 111, 121 into the waveguide 100 as the set of in-coupled beams 112, 122 from to the first side 201 or from the second side 202 of the waveguide 100. Thus, the side from which the in-couple structure 110 is configured to in-couple the set of input beams 111, 121 into the waveguide 100 does not depend on which side of the waveguide 100 the in-couple structure 110 is positioned.

In any embodiment disclosed herein, the in-couple structure 110 and/or the first diffracting structure 101 and/or the second diffracting structure 102 may comprise reflective or transmissive diffractive gratings. The side to which the the first diffracting structure 101 and/or the second diffracting structure 102 is configured to out-couple the diffracted set of beams from the waveguide 100 may be the same side or the opposite side from the side from which the in-couple structure 110 is configured to in-couple the set of input beams into the waveguide 100. Thus, a projector generating an image corresponding to the set of input beams may be on the same side or on the opposite side from an eye of a user viewing the image corresponding to the set of output beams.

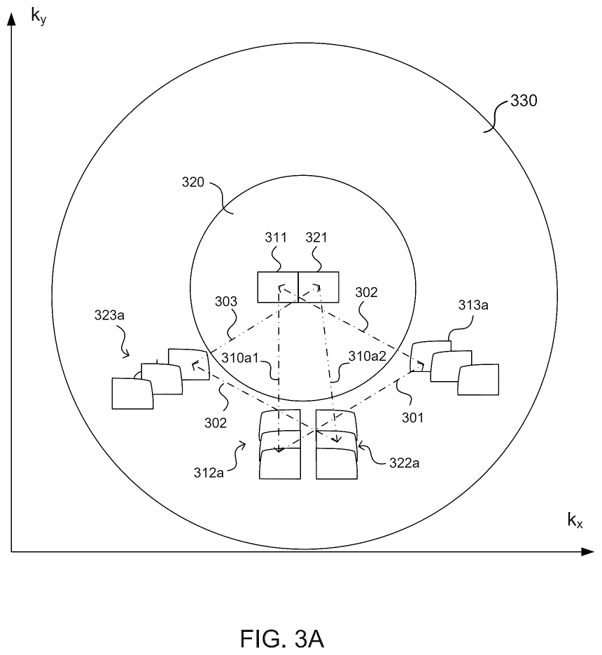

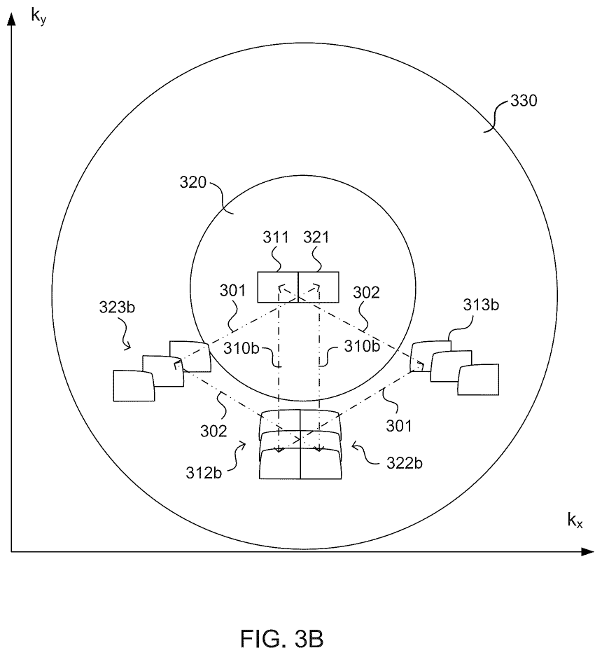

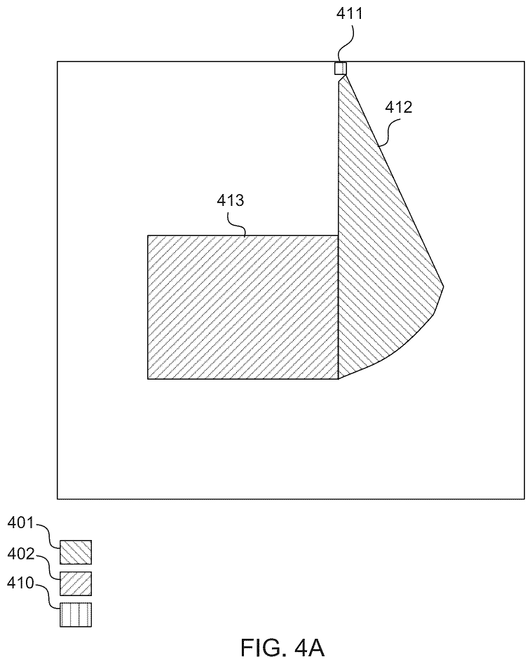

FIGS. 3A and 3B illustrate a k-space representation of grating vectors and transitions in the wave-guide according to an example embodiment.

The example embodiment of FIGS. 3A and 3B illustrate at least some of the possible transitions in k-space for a display structure described in relation to FIG. 1.

As illustrated by FIG. 3A, according to an example embodiment, the in-coupling structure 110 comprises an in-coupling diffractive grating 110al with an in-coupling grating vector 310al, and in-coupling diffractive grating 110a2 with an in-coupling grating vector 310a2. In-coupling grating vectors 310al and 310a2 can be identical or different. The first diffracting structure 101 comprises a first one-dimensional diffractive grating with a first grating vector 301. The second diffracting structure 102 comprises a second one-dimensional diffractive grating with a second grating vector 302. The second OC structure 103 comprises a second OC one-dimensional diffractive grating with a second OC grating vector 303. The sum of the in-coupling grating vector 310a1, the first grating vector 301, and the second grating vector 302 is substantially equal to zero. The sum of the in-coupling grating vector 310a2, the second grating vector 302, and the second OC grating vector 303 is substantially equal to zero.

As illustrated by FIG. 3B, according to an example embodiment, the in-coupling structure 110 comprises an in-coupling diffractive grating 110b with an in-coupling grating vector 310b. The first diffracting structure 101 comprises a first one-dimensional diffractive grating with a first grating vector 301. The second diffracting structure 102 comprises a second one-dimensional diffractive grating with a second grating vector 302. The sum of the in-coupling grating vector 310b, the first grating vector 301, and the second grating vector 302 is substantially equal to zero.

The grating vectors may represent the periodicity and orientation of the corresponding diffractive gratings. For example, a diffractive grating can comprise ridges/grooves and the grating vectors can correspond to the spatial periodicity and orientation of these ridges/grooves. The structure of these ridges/grooves define the diffraction caused by the diffractive grating. Length of a grating vector may be inversely proportional to the spatial period of the corresponding diffractive grating in the direction of the grating vector. Thus, the ridges/grooves of the diffractive grating may run along a direction perpendicular to the direction of the grating vector.

It should be appreciated that the grating vector for a specific diffractive grating can be chosen in various ways. For example, for a one-dimensional grating, there may be two possible grating vectors pointing in the opposite directions that describe the same one-dimensional grating. Thus, in some embodiments disclosed herein, the grating vectors may be illustrated as two-way arrows.

Each k-vector in k-space can represent a propagation direction of a beam inside the waveguide 100. The magnitude of each k-vector corresponds to a wave-number k. A k-vector can be expressed as k=n\hat{v}, where n is the refractive index of the medium of the waveguide 100 and \hat{v} is a unit vector pointing towards the propagation direction of the k-vector. k may also be referred to as a normalized k-vector.

The waveguide 100 can guide beams having certain k-vectors via total internal reflection (TIR). A coupling domain 320 corresponds to k-vectors that do not have sufficient x and/or y components to be guided inside the waveguide 100 via TIR. Here, the x and y axes are in the plane of the waveguide 100 while the z axis is along a thickness direction of the waveguide 100. For such beams, the angle between the beam and the sur-face(s) of the waveguide 100 is not sufficient to cause TIR as governed by Snell's law. K-vectors inside the annular guided propagation domain 330 have sufficient x and/or y components to be guided inside the waveguide 100 via TIR. K-vectors at the outer circumference of the annular guided propagation domain 330 correspond to beams propagating along the plane of the waveguide 100, i.e., such beams do not have any z component. Radius of the coupling domain 320 may be 1 and radius of the annular guided propagation domain 330 may be n.

According to an example embodiment, the guided propagation domain 330 surrounds a coupling domain 320.

Herein, a transition in k-space may correspond to an interaction of a set of beams with a diffractive grating. Such an interaction can cause the set of beams to propagate into a different direction or directions than before the interaction. The change in propagation direction can be observed as a translation in k-space along a transition.

In the embodiments disclosed herein, some transitions correspond to grating vectors and are therefore illustrated using the grating vectors in k-space. For example, in the example embodiments of FIGS. 3A and 3B, the grating vectors 310a1, 310a2, 310b, 301, 302 also correspond to possible transitions in k-space.

The first and second sets of input beams 111, 121 can be associated with corresponding input images 311, 321 respectively. The in-coupling structure 110 can couple the sets of input beams 111, 121 into the wave-guide 100 as the sets of in-coupled beams 112, 122 respectively. The sets of in-coupled beams 112, 122 can be associated with a set of in-coupled images 312, 322 respectively.

In terms of k-space representation, this can be illustrated as the input images 311, 321 being translated in k-space along a transition 310 (310a1 and 310a2 on FIGS. 1A, 310b on FIG. 1B) corresponding to diffractions caused by the in-coupling structure 110, resulting in sets of in-coupled images 312 (312a on FIGS. 1A, 312b on FIGS. 1B), 322 (322a on FIGS. 1A, 322b on FIG. 1B) respectively.

As illustrated by FIG. 3A, according to an example embodiment, the input image 311 is translated in k-space along a transition 310a1 corresponding to diffractions caused by the in-coupling structure 110a1, resulting in sets of in-coupled images 312a. The input image 321 is translated in k-space along a transition 310a2 corresponding to diffractions caused by the in-coupling structure 110a2, resulting in sets of in-coupled images 322a.

As illustrated by FIG. 3B, according to an example embodiment, the input images 311, 321 are translated in k-space along a transition 310b corresponding to diffractions caused by the in-coupling structure 110b, resulting in sets of in-coupled images 312b, 322b respectively.

The different k-vectors in each set of in-coupled images 312, 322 may correspond to, for example, different colours and/or different parts of an image represented by the corresponding set of input beams. For example, each set of input beams may comprise green, blue, and red channels. Due to the different wavelength of each such colour channel, each colour may occupy a different part of the k-space. For example, in the embodiments of FIGS. 3A and 3B, each of the three rectangles in the set of in-coupled images 312, 322 may correspond to a colour channel of the image represented by the set of input beams 111, 121.

The first diffracting structure 101 may receive the first set of in-coupled beams 112 and diffract the first set of in-coupled beams 112 in a plurality of directions producing the first diffracted set of beams 113. In terms of k-space representation, this can be illustrated as the in-coupled images 312 (312a on FIGS. 1A, 312b on FIG. 1B) being translated in k-space along a transition 301 corresponding to diffractions caused by the first diffracting structure 101, resulting in the set of diffracted images 313 (313a on FIGS. 1A, 313b on FIG. 1B).

The second diffracting structure 102 may receive, from the first diffracting structure 101, the diffracted set of beams 113 and out-couple the diffracted set of beams 113 from the waveguide 100 as a set of output beams 114. In terms of k-space representation, this can be illustrated as the set of diffracted images 313 being translated in k-space from propagation domain 330 into the coupling domain 320 along a transition 302 corresponding to diffractions caused by the second diffracting structure 102.

The second diffracting structure 102 may receive the second set of in-coupled beams 122 and diffract the second set of in-coupled beams 122 in a plurality of directions producing the second diffracted set of beams 123. In terms of k-space representation, this can be illustrated as the second in-coupled image 322 being translated in k-space along a transition 302 corresponding to diffractions caused by the second diffracting structure 102, resulting in the second set of diffracted images 323.

As illustrated by FIG. 3A, the second out-coupling (OC) structure 103 may receive, from the second diffracting structure 102, the second diffracted set of beams 123a and out-couple the second diffracted set of beams 123a from the waveguide 100 as a second set of output beams 124. In terms of k-space representation, this can be illustrated as the second set of diffracted images 323a being translated in k-space from propagation domain 330 into the coupling domain 320 along a transition 303 corresponding to diffractions caused by the second out-coupling (OC) structure 103.

As illustrated by FIG. 3B, the first diffracting structure 101 may act as the out-coupling (OC) structure for the second diffracted set of beams 123b. The first diffracting structure 101 may receive, from the second diffracting structure 102, the second diffracted set of beams 123b and out-couple the second diffracted set of beams 123b from the waveguide 100 as a second set of output beams 124. In terms of k-space representation, this can be illustrated as the second set of diffracted images 323b being translated in k-space from propagation domain 330 into the coupling domain 320 along a transition 301 corresponding to diffractions caused by the first diffracting structure 101.

For example, in the embodiments of FIGS. 3A and 3B, images 311, 321 corresponding to the sets of input beams 111, 121 are located in the coupling domain 320 of the k-space. The in-coupling structure 110 may comprise, for example, a diffractive grating that can couple the sets of input beams 111, 121 into the waveguide 100. As can be seen in the embodiments of FIGS. 3A and 3B, since the first and second in-coupled images 312, 322 are inside the annular guided propagation domain 230, the corresponding sets of in-coupled beams 112, 122 are guided inside the waveguide 100 via TIR.

Although in some embodiments disclosed herein the images 321, 311 corresponding to the set of input beams 121, 111 are located at the k-space origin, this may not be the case for all embodiments. For example, if the set of input beams 121, 111 is not perpendicular to the waveguide 100, the images 321, 311 corresponding to the set of input beams 121, 111 may be located in some other part of the coupling domain 320.

FIGS. 4A to 4B illustrate a plan view of a display structure according to an example embodiment in the plan of the waveguide. The example embodiment of FIGS. 4A to 4B may be in accordance with any of the example embodiments disclosed with reference to and/or in conjunction with FIG. 1 to 3.

FIG. 4A illustrates functional areas for the first light path (e.g., corresponding to the first section of the field of view).

A first IN functional area 411 is configured for in-coupling (IN) the first section of the field of view. A diffractive function 410 of the first IN functional area 411 corresponds to the in-coupling grating vector 310.

A first EPE functional area 412 is configured for exit pupil expansion (EPE) for the first section of the field of view. A diffractive function 401 of the first EPE functional area 412 corresponds to the first grating vector 301.

A first OC functional area 413 is configured for out-coupling (OC) for the first section of the field of view. A diffractive function 402 of the first OC functional area 413 corresponds to the second grating vector 302.

FIG. 4B illustrates functional areas for the second light path (e.g., corresponding to the second section of the field of view).

A second IN functional area 421 is configured for in-coupling (IN) the second section of the field of view. A diffractive function 410 of the second IN functional area 421 corresponds to the in-coupling grating vector 310.

A second EPE functional area 422 is configured for exit pupil expansion (EPE) for the second section of the field of view. A diffractive function 402 of the second EPE functional area 422 corresponds to the second grating vector 302.

A second OC functional area 423 is configured for out-coupling (OC) the second section of the field of view. A diffractive function 401 of the second OC functional area 423 corresponds to the first grating vector 301.

FIG. 4 AB illustrates the superposition of the functional areas for the first and second light paths (e.g., for the first and second sections of the field of view).

Sections where two functional areas with the same diffractive function overlap may be realized using a one-dimensional grating.

In particular, when an EPE functional area and an OC functional area having the same grating vector overlap, a single one-dimensional grating may be used to perform both exit pupil expansion (EPE) and out-coupling (OC). As such, the surface area of the structure can be reduced and/or the field of view (FOV) can be increased without increasing the surface area of the structure.

For example, the first EPE functional area 412 and the second OC functional area 423 have the same grating vector 301 and overlap in a first EPE/OC overlap section 451. The second EPE functional area 422 and the first OC functional area 413 have the same grating vector 302 and overlap in a second EPE/OC overlap section 452.

In one or more of the EPE/OC overlap sections, a single one-dimensional grating may be used to perform both exit pupil expansion (EPE) and out-coupling (OC). For example, a first one-dimensional diffractive grating with a first grating vector 301 (e.g., the first diffracting structure 101) may be used to perform both exit pupil expansion (EPE) and out-coupling (OC) in the first overlap section 451. Similarly, a second one-dimensional diffractive grating with a second grating vector 302 (e.g., the second diffracting structure 102) may be used to perform both exit pupil expansion (EPE) and out-coupling (OC) in the second overlap section 452.

Sections where two functional areas with different diffractive functions overlap may be realized using a two-dimensional grating combining the different diffractive functions or two one-dimensional gratings on either side of the waveguide. Sections where three functional areas with different diffractive functions overlap may be realized using a two-dimensional grating combining two of the different diffractive functions on one side and a one-dimensional grating on the other side of the waveguide. Embedded gratings in the middle of waveguide may also be used.

Herein, a section of the waveguide 100 may refer to any section, such as a subsection, of the wave-guide 100 in the plane of the waveguide 100. Thus, a section may comprise both the first side 201 and the second side 202 of the waveguide 100. Herein, an overlap may refer to overlap in dimensions along the plane of the waveguide 100. The sections may overlap only partially.

FIG. 5 illustrates a schematic representation of a display structure according to an example embodiment. The example embodiment of FIG. 5 may be in accordance with any of the example embodiments disclosed with reference to and/or in conjunction with FIG. 1 to 4.

The display structure 1000 may further comprise an interspaced diffracting structure 501. The interspaced diffracting structure 501 ensures the continuity of the field of view.

The interspaced diffracting structure 501 may extend between the first diffracting structure 101 and the second diffracting structure 102. The interspaced diffracting structure 501 may cover at least partially the sections of the waveguide 100 that are not covered by either the first diffracting structure 101 or the second diffracting structure 102.

As illustrated by FIG. 6A, the interspaced diffracting structure 501 may comprise an overlap of two one-dimensional diffractive gratings on the waveguide 100. More specifically, the interspaced diffracting structure 501 may comprise an overlap of the one-dimensional diffractive grating of the first diffracting structure 101 on one surface of the waveguide 100 and of the one-dimensional diffractive grating of the second diffracting structure 102 on the other surface of the waveguide 100.

As illustrated by FIG. 6B, the interspaced diffracting structure 501 may comprise one two-dimensional diffractive grating on a surface of the waveguide 100. More specifically, the two-dimensional diffractive grating may be a combination of the one-dimensional diffractive grating of the first diffracting structure 101 and the one-dimensional diffractive grating of the second diffracting structure 102.

The interspaced diffracting structure 501 may act as both an out-coupling (OC) structure and an exit pupil expansion (EPE) structure. In particular, the interspaced diffracting structure 501 may act as an out-coupling (OC) structure for both the first diffracted set of beams 113, and the second diffracted set of beams 123. The interspaced diffracting structure 501 may act as an exit pupil expansion (EPE) structure for both the first set of in-coupled beams 112, and the second set of in-coupled beams 122.

The first set of in-coupled beams 112 and the first diffracted set of beams 113 may interact with the interspaced diffracting structure 501 a plurality of times before the first diffracted set of beams 113 is out-coupled from the waveguide 100 as the first set of output beams 114.

The second set of in-coupled beams 122 and the second diffracted set of beams 123 may interact with the interspaced diffracting structure 501 a plurality of times before the second diffracted set of beams 123 is out-coupled from the waveguide 100 as the second set of output beams 124.

It should be understood that the geometry of the display structure 100 illustrated in the embodiment of FIG. 5 is only exemplary and the display structure may be implemented in various other ways.

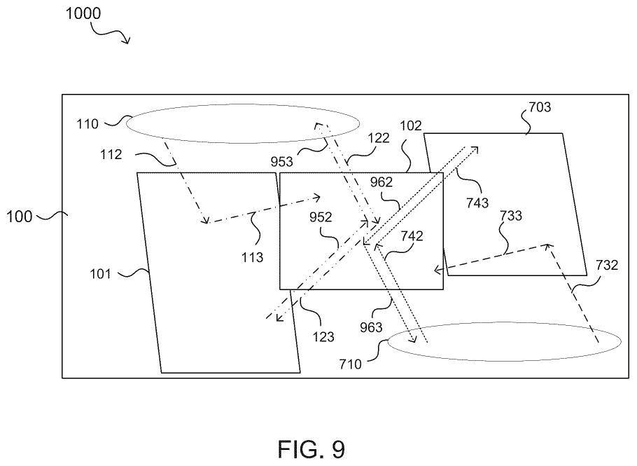

FIG. 7 illustrates a schematic representation of a display structure according to an example embodiment. The example embodiment of FIG. 7 may be in accordance with any of the example embodiments disclosed with reference to and/or in conjunction with FIG. 1 to 6A and 6B.

The display structure 1000 may further comprise a second in-coupling (IC) structure 710 configured to couple light into the waveguide 100. More specifically, the second in-coupling structure 710 may couple a third set of input beams 731 into the waveguide 100 as a third set of in-coupled beams 732, and a fourth set of input beams 741 into the waveguide 100 as a fourth set of in-coupled beams 742.

The second in-coupling (IC) structure 710 may be in accordance with any of the example embodiments of the in-coupling structure 110. In particular, the second in-coupling (IC) structure 710 may comprise a diffractive grating on a surface of the waveguide 100. The second in-coupling (IC) structure 710 may comprise at least two joint or disjoint grating areas.

The display structure 1000 may further comprise a third diffracting structure 703. The third diffracting structure 703 may be in accordance with any of the example embodiments of the first diffracting structure 101. In particular, the third diffracting structure 703 may comprise a third one-dimensional diffractive grating with a third grating vector 803. The third grating vector 803 is equal to the first grating vector 301. The third diffracting structure 703 may simultaneously play the role of out-coupling (OC) structure and exit pupil expansion (EPE) structure.

The third diffracting structure 703 may act as an exit pupil expansion (EPE) structure for the third set of in-coupled beams 732. In particular, the third diffracting structure 703 may receive the third set of in-coupled beams 732 and diffract the third set of in-coupled beams 732 in a plurality of directions, producing a third diffracted set of beams 733.

The second diffracting structure 102 may act as an out-coupling (OC) structure for the third diffracted set of beams 733. In particular, the second diffracting structure 102 may be configured to receive, from the third diffracting structure 703, the third diffracted set of beams 733, to out-couple the third diffracted set of beams 733 from the waveguide 100 as a third set of output beams 734.

The second diffracting structure 102 may act as an exit pupil expansion (EPE) structure for the fourth set of in-coupled beams 742. In particular, the second diffracting structure 102 may receive the fourth set of in-coupled beams 742 and diffract the fourth set of in-coupled beams 742 in a plurality of directions, producing a fourth diffracted set of beams 743.

The third diffracting structure 703 may act as an out-coupling (OC) structure for the second diffracted set of beams 743. In particular, the third diffracting structure 703 may be configured to receive, from the second diffracting structure 102, the fourth diffracted set of beams 743, to out-couple the fourth diffracted set of beams 743 from the waveguide 100 as a fourth set of output beams 744.

Beams 731, 732, 733, 734 form a third light path e.g., from the optical engine to the user eye.

Beams 741, 742, 743, 744 form a fourth light path e.g., from the optical engine to the user eye.

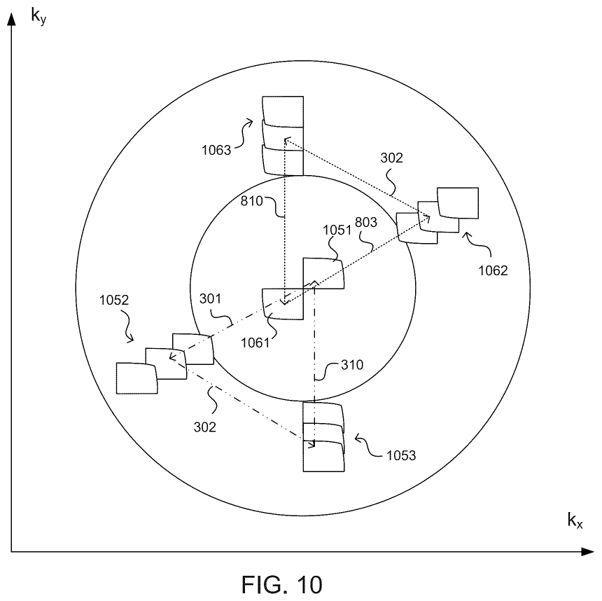

FIG. 8 illustrates a k-space representation of grating vectors and transitions in the waveguide according to an example embodiment.

The example embodiment of FIG. 8 illustrates at least some of the possible transitions in k-space for a display structure described in relation to FIG. 7. The possible transitions include the transitions described in relation to FIGS. 3A and 3B.

Transitions 810 indicated in the example embodiment of FIG. 8 can occur due to diffraction caused by the second in-coupling structure 710. Transitions 803 indicated in the embodiment of FIG. 8 can occur due to diffraction caused by the third diffracting structure 703.

The third and fourth sets of input beams can be associated with corresponding input images 831, 841 respectively. The second in-coupling structure 710 can couple the third and fourth sets of input beams into the waveguide 100 as the third and fourth sets of in-coupled beams 732, 742 respectively. The sets of in-coupled beams 732, 742 can be associated with a set of in-coupled images 832, 842 respectively. In terms of k-space representation, this can be illustrated as the input images 831, 841 being translated in k-space along a transition 810 corresponding to diffractions caused by the in-coupling structure 710, resulting in sets of in-coupled images 832, 842 respectively.

The third diffracting structure 703 can receive the first set of in-coupled beams 732 and diffract the third set of in-coupled beams 732 in a plurality of directions producing the third diffracted set of beams 733. In terms of k-space representation, this can be illustrated as the in-coupled images 832 being translated in k-space along a transition 803 corresponding to diffractions caused by the third diffracting structure 703, resulting in the third set of diffracted images 833.

The second diffracting structure 102 may receive, from the third diffracting structure 703, the third diffracted set of beams 733 and out-couple the third diffracted set of beams 733 from the waveguide 100 as a third set of output beams 734. In terms of k-space representation, this can be illustrated as a transition from propagation domain 330 into the coupling domain 320 along the second grating vector 302.

The second diffracting structure 102 may receive the fourth set of in-coupled beams 742 and diffract the second set of in-coupled beams 742 in a plurality of directions producing the fourth diffracted set of beams 743. In terms of k-space representation, this can be illustrated as the second in-coupled image 842 being translated in k-space along a transition 302 corresponding to diffractions caused by the second diffracting structure 102, resulting in the fourth set of diffracted images 843.

The third diffracting structure 703 may receive, from the second diffracting structure 102, the fourth diffracted set of beams 843 and out-couple the fourth diffracted set of beams 843 from the waveguide 100 as the fourth set of output beams 744. In terms of k-space representation, this can be illustrated as a transition from propagation domain 330 into the coupling domain 320 along the third grating vector 803.

FIGS. 4C and 4D illustrate a plan view of a display structure according to an example embodiment in the plan of the waveguide. The example embodiment of FIGS. 4D and 4D may be in accordance with any of the example embodiments disclosed with reference to and/or in conjunction with FIG. 1 to 8.

FIG. 4C illustrates functional areas for the third path (e.g., corresponding to the third section of the field of view).

A third IN functional area 431 is configured for in-coupling (IN) the third section of the field of view. A diffractive function 410 of the third IN functional area 431 corresponds to the in-coupling grating vector 310.

A third EPE functional area 432 is configured for exit pupil expansion (EPE) for the third section of the field of view. A diffractive function 401 of the third EPE functional area 432 corresponds to the first grating vector 301.

A third OC functional area 433 is configured for out-coupling (OC) the third section of the field of view. A diffractive function 402 of the third OC functional area 433 corresponds to the second grating vector 302.

FIG. 4D illustrates functional areas for the fourth path (e.g., corresponding to the fourth section of the field of view).

A fourth IN functional area 441 is configured for in-coupling (IN) the fourth section of the field of view. A diffractive function 410 of the fourth IN functional area 441 corresponds to the in-coupling grating vector 310.

A fourth EPE functional area 442 is configured for exit pupil expansion (EPE) for the fourth section of the field of view. A diffractive function 402 of the fourth EPE functional area 442 corresponds to the second grating vector 302.

A fourth OC functional area 443 is configured for out-coupling (OC) the fourth section of the field of view. A diffractive function 401 of the fourth f OC functional area 443 corresponds to the first grating vector 301.

FIG. 4 ABCD illustrates the superposition of the functional areas for the first, second, third, and fourth light paths.

The third EPE functional area 432 and the second OC functional area 423 have the same grating vector 301 and overlap in a third EPE/OC overlap section 453. The fourth EPE functional area 442 and the first OC functional area 413 have the same grating vector 302 and overlap in a fourth EPE/OC overlap section 454.

In the third EPE/OC overlap section 453 and/or the fourth EPE/OC overlap section 404, a single one-dimensional grating may be used to perform both exit pupil expansion (EPE) and out-coupling (OC). For example, a one-dimensional diffractive grating with a second grating vector 302 (e.g., the second diffracting structure 102) may be used to perform both exit pupil expansion (EPE) and out-coupling (OC) in the fourth EPE/OC overlap section 454. Similarly, a one-dimensional diffractive grating with a first grating vector 301 (e.g., the first diffracting structure 101) may be used to perform both exit pupil expansion (EPE) and out-coupling (OC) in the third EPE/OC overlap section 453.

FIG. 9 illustrates a schematic representation of a display structure according to an example embodiment. The example embodiment of FIG. 9 may be in accordance with any of the example embodiments disclosed with reference to and/or in conjunction with FIG. 1 to 8.

The first in-coupling structure 110 and/or the second in-coupling structure 710 may act as both in-coupling structure and out-coupling structure.

For example, the first diffracting structure 101 may act as an in-coupling structure for a fifth set of in-coupled beams 952. The second diffracting structure 102 may act as an exit pupil expansion (EPE) structure for the fifth set of in-coupled beams 952. The first in-coupling structure 110 may act as out-coupling (OC) structure for the fifth diffracted set of beams 953.

More specifically, the first diffracting structure 101 may couple a fifth set of input beams into the waveguide 100 as a fifth set of in-coupled beams 952. The second diffracting structure 102 may receive the fifth set of in-coupled beams 952 and diffract the fifth set of in-coupled beams 952 in a plurality of directions, producing a fifth diffracted set of beams 953. The first in-coupling structure 110 may receive, from the second diffracting structure 102, the fifth diffracted set of beams 953, and out-couple the fifth diffracted set of beams 953 from the waveguide 100.

As another example, the third diffracting structure 703 may act as an in-coupling structure for a sixth set of in-coupled beams 962. The second diffracting structure 102 may act as an exit pupil expansion (EPE) structure for the sixth set of in-coupled beams 962. The second in-coupling structure 710 may act as out-coupling (OC) structure for the sixth diffracted set of beams 963.

More specifically, the third diffracting structure 703 may couple a sixth set of input beams into the waveguide 100 as a sixth set of in-coupled beams 962. The second diffracting structure 102 may receive the sixth set of in-coupled beams 962 and diffract the sixth set of in-coupled beams 962 in a plurality of directions, producing a sixth diffracted set of beams 963. The second in-coupling structure 710 may receive, from the second diffracting structure 102, the sixth diffracted set of beams 963, and out-couple the sixth diffracted set of beams 963 from the waveguide 100.

When using a same grating area for in-coupling and out-coupling, the safety of the user eye should be considered. In particular, direct reflection of the projector light into the eye should be avoided.

FIG. 10 illustrates a k-space representation of grating vectors and transitions in the waveguide according to an example embodiment.

The example embodiment of FIG. 10 illustrates at least some of the possible transitions in k-space for a display structure described in relation to FIG. 9. The possible transitions in k-space for a display structure described in relation to FIG. 9 include the possible transitions described in relation to FIG. 3 A and 3B and 8 that are not represented on FIG. 10 for clarity.

The fifth and sixth sets of input beams can be associated with corresponding input images 1051, 1061 respectively.

The input image 1051 is translated in k-space along a transition 301 corresponding to diffractions caused by the first diffracting structure 101, resulting in sets of in-coupled images 1052. The in-coupled images 1052 are translated in k-space along a transition 302 corresponding to diffractions caused by the second diffracting structure 102, resulting in the third set of diffracted images 1053. The the third set of diffracted images 1053 are translated from propagation domain 330 into the coupling domain 320 along the in-coupling grating vector 310.

The input image 1061 is translated in k-space along a transition 803 corresponding to diffractions caused by the third diffracting structure 703, resulting in sets of in-coupled images 1062. The in-coupled images 1062 are translated in k-space along a transition 302 corresponding to diffraction caused by the second diffracting structure 102, resulting in the third set of diffracted images 1063. The third set of diffracted images 1063 are translated from propagation domain 330 into the coupling domain 320 along the second in-coupling grating vector 810.

It should be appreciated that the sets of beams illustrated in the example embodiments of FIGS. 1, 5, 7 and 9 are only illustrative. In practical embodiments, the first diffracting structure 101, the second diffracting structure 102, and/or the third diffracting structure 703 can diffract the sets of beams in a plurality of directions in a much more complex manner and the sets of beams can interact with the first diffracting structure 101, the second diffracting structure 102, and/or the third diffracting structure 703 a plurality of times.

It should be understood that the geometry of the display structure illustrated in the embodiment of FIGS. 1, 5, 7 and 9 is only exemplary and the display structure may be implemented in various other ways.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A display structure, comprising:
a waveguide;
an in-coupling structure configured to couple a first set of input beams into the waveguide as a first set of in-coupled beams, and a second set of input beams into the waveguide as a second set of in-coupled beams;
a first one-dimensional diffractive grating structure configured to receive the first set of in-coupled beams, and to diffract the first set of in-coupled beams producing a first diffracted set of beams; and
a second one-dimensional diffractive grating structure configured to receive the second set of in-coupled beams, and to diffract the second set of in-coupled beams producing a second diffracted set of beams;
wherein the first one-dimensional diffractive grating structure is further configured to receive, from the second diffracting structure, the second diffracted set of beams, and to out-couple the second diffracted set of beams from the waveguide;
wherein the display structure further comprises:
a second in-coupling structure configured to couple a third set of input beams into the waveguide as a third set of in-coupled beams; and
a third one-dimensional diffractive grating structure configured to receive the third set of in-coupled beams, and to diffract the third set of in-coupled beams producing a third diffracted set of beams;
wherein the second one-dimensional diffractive grating is further configured to receive, from the third one-dimensional diffractive grating structure, the third diffracted set of beams, and to out-couple the third diffracted set of beams from the waveguide;
wherein the second in-coupling structure is further configured to couple a fourth set of input beams into the waveguide as a fourth set of in-coupled beams, and
wherein the second one-dimensional diffractive grating is further configured to receive the fourth set of in-coupled beams, and to diffract the fourth set of in-coupled beams producing a fourth diffracted set of beams;
wherein the third one-dimensional diffractive grating structure is further configured to receive, from the second one-dimensional diffractive grating, the fourth diffracted set of beams, and to out-couple the fourth diffracted set of beams from the waveguide.

2. The display structure according to claim 1, wherein the second one-dimensional diffractive grating structure is further configured to receive, from the first one-dimensional diffractive grating structure, the first diffracted set of beams, and to out-couple the first diffracted set of beams from the waveguide.

3. The display structure according to claim 1, wherein the in-coupling structure comprises an in-coupling one-dimensional diffractive grating with an in-coupling grating vector, the first one-dimensional diffractive grating structure corresponds to a first grating vector, the second one-dimensional diffractive grating structure corresponds to a second grating vector, and wherein a sum of the in-coupling grating vector, the first grating vector, and the second grating vector is substantially equal to zero.

4. The display structure according to claim 1, wherein the display structure further comprises an interspaced diffracting structure extending at least partially between the first one-dimensional diffractive grating structure and the second one-dimensional diffractive grating structure.

5. The display structure according to claim 4, wherein the interspaced diffracting structure comprises an overlap of the first one-dimensional diffractive grating structure and of the second one-dimensional diffractive grating structure.

6. The display structure according to claim 4, wherein the interspaced diffracting structure comprises a two-dimensional diffractive grating combining a first grating vector of the first one-dimensional diffractive grating structure and a second grating vector of the second one-dimensional diffractive grating structure.

7. The display structure according to claim 1,
wherein the third one-dimensional diffractive grating structure is further configured to couple a sixth set of input beams into the waveguide as a sixth set of in-coupled beams;
wherein the second one-dimensional diffractive grating structure is further configured to receive the sixth set of in-coupled beams, and to diffract the sixth set of in-coupled beams producing a sixth diffracted set of beams;
wherein the second in-coupling structure is further configured to receive, from the second one-dimensional diffractive grating structure the sixth diffracted set of beams, and to out-couple the sixth diffracted set of beams from the waveguide.

8. The display structure according to claim 1,
wherein the first one-dimensional diffractive grating structure is further configured to couple a fifth set of input beams into the waveguide as a fifth set of in-coupled beams;
wherein the second one-dimensional diffractive grating structure is further configured to receive the fifth set of in-coupled beams and diffract the fifth set of in-coupled beams producing a fifth diffracted set of beams;
the first in-coupling structure is further configured to receive, from the second one-dimensional diffractive grating structure, the fifth diffracted set of beams and to out-couple the fifth diffracted set of beams from the waveguide.

9. A display device comprising a display structure according to claim 1.

10. A display device according to claim 1, comprising a scanner-based optical engine, e.g., a laser-scanning optical engine, for directing the one or more sets of input beams to the in-coupling structure.

11. A display device according to claim 9 implemented as a see-through display device.

12. A display device according to claim 9 implemented as a head-mounted display device.
